(19) United States
(12) Patent Application Publication
(10) Pub. No.: US 2018/0285154 A1
(43) Pub. Date: Oct. 4, 2018

(54) MEMORY RING-BASED JOB DISTRIBUTION FOR PROCESSOR CORES AND CO-PROCESSORS

(71) Applicant: Intel Corporation, Santa Clara, CA (US)

(72) Inventors: John J. Browne, Limerick (IE); Chris MacNamara, Limerick (IE); Tomasz Kantecki, Ennis (IE); Stephen Doyle, Ennis (IE); Sean Harte, Limerick (IE); Niall Power, Limerick (IE)

(21) Appl. No.: 15/473,885

(22) Filed: Mar. 30, 2017

(51) Int. Cl. G06F 9/48; G06F 9/50

(52) U.S. Cl. CPC G06F 9/4887; G06F 9/5083

(57) ABSTRACT

An apparatus includes a processor, a co-processor and a memory ring. The memory ring includes a plurality of slots that are associated with a plurality of jobs. The processor is to apply a set of rules and based on the application of the set of rules, selectively access a first slot of the plurality of slots to read first data stored in the first slot representing a first job of the plurality of jobs and process the first job based on the first data. The co-processor is to apply the set of rules and based on the application of the set of rules, access a second slot of the plurality of slots other than the first slot to read second data representing a second job of the plurality of jobs and process the second job based on the second data.

### BACKGROUND

A computer system may contain one or multiple central processing units (CPUs), and a given CPU may be part of an integrated device package and contain multiple processing cores. The computing system may further include one or multiple co-processors that supplement functions of the CPU processing cores. In this regard, a given co-processor may have a relatively limited instruction set (as compared to a CPU processing core, for example) and may be dedicated to performing one or multiple specific functions, such as graphics processing, floating point arithmetic, digital signal processing, cryptography functions, input/output processing, compression, decompression, and so forth. In general, the use of co-processors allows a computer system to be configured for a specific application in a cost effective manner and customized for accelerated system performance.

### BRIEF DESCRIPTION OF THE DRAWINGS

FIG. 1 is a schematic diagram of a network according to an example implementation.

FIG. 2 is a schematic diagram of an electronic device of the network of FIG. 1 according to an example implementation.

FIG. 3 illustrates a pull-based load distribution management environment for distributing jobs among central processing unit (CPU) cores and co-processors according to an example implementation.

FIG. 4 is an illustration of the use of a shared memory ring to distribute jobs among CPU cores and co-processors according to an example implementation.

FIG. 5 is a flow diagram depicting a technique to distribute loads among CPU cores and co-processors using a shared memory ring according to an example implementation.

FIG. 6 is a flow diagram illustrating processing of a data packet according to an example implementation.

FIG. 7 is a flow diagram depicting a technique used by a co-processor to process jobs using the shared memory ring according to an example implementation.

FIG. 8 is a flow diagram depicting a technique used by a CPU core to process jobs using the shared memory ring according to an example implementation.

FIG. 9 is a flow diagram depicting a technique to build hardware descriptors for co-processor jobs according to an example implementation.

FIG. 10 is an illustration of data stored in slots of the shared memory ring for the example case in which the data packet associated with each slot is processed by a single co-processor according to an example implementation.

FIG. 11 is an illustration of data stored in slots of the shared memory ring for the example case in which multiple co-processors process the same data packet according to an example implementation.

FIG. 12 illustrates a push-based load distribution management environment for distributing jobs among CPU cores and co-processors according to an example implementation.

### DETAILED DESCRIPTION

In accordance with example implementations that are described herein, an electronic device of a computer network may control communications of data packets between source and destination endpoint nodes. In accordance with example implementations, the electronic device may be one of the source or destination endpoint nodes; circuitry contained in one of the source or destination endpoint nodes; a network fabric component (a switch or a gateway, as examples) disposed between source and endpoint nodes; and so forth.

The electronic device may perform such functions as decryption, encryption, compression, decompression, network protocol layer processing, and so forth. For this purpose, the electronic device may include one or multiple processors, such as one or multiple central processing units (CPUs), as well as one or multiple co-processors. Moreover, a given CPU may contain one or multiple processing cores. Although a given co-processor may have a limited instruction set as compared to a CPU core, the co-processor may be tailored to specifically perform a given function, such as a function related to compression, decompression, cryptography, and so forth.

In accordance with example implementations, the co-processors and CPU cores of the electronic device may perform different tasks, or jobs, pertaining to the processing of network data packets. For example, the CPU cores may process jobs associated with one or multiple network protocol layers, a given co-processor may perform data compression/decompression-related jobs, another co-processor may perform encryption/decryption-related jobs, and so forth. In accordance with some implementations, a given job may be performed by either a CPU core or a co-processor.

One way to distribute the job processing load among the CPU cores and co-processors is to use a push-based approach, in which hardware descriptors describing jobs for specific co-processors are stored in, or pushed to, a queue; and with this arrangement, the co-processors retrieve the stored hardware descriptors and process the corresponding jobs as the hardware descriptors appear at the top of the queue. The co-processors may complete the jobs at different times, and accordingly, with the push-based approach, a reordering stage may be used for purposes of placing the completed, or processed, data packets back into the correct temporal order (i.e., the temporal order in which the data packets were received from the network fabric) before the network data packets are transmitted to the network fabric.

In accordance with example implementations that are described herein, an electronic device contains a lockless, shared memory ring, which may be used, for example, in a pull-based approach to distribute jobs among CPU cores and co-processors of the electronic device so that the CPU cores and co-processors pull jobs for processing on a demand basis. More specifically, in accordance with example implementations, the shared memory ring refers to a circular data array structure in memory containing locations, or slots. In general, a given slot is associated with a data packet, and the data packet may be, at a given time, in one of several states: an unprocessed state, a being processed state, a processed state, and so forth. The slots may be indexed sequentially in a manner that causes the last slot (the slot having the highest associated index number) to wrap to the first slot.

The shared memory ring has an associated temporal order: the slots of the shared memory ring may be indexed corresponding to the temporal order in which data packets are received from the network fabric. For example, slot number three of the memory ring may be associated with a data packet that was received from the network fabric after a data packet that is associated with slot number two. Access to the shared memory ring does not, in accordance with example implementations, involve the use of locks, as multiple CPU cores and co-processors may access the shared memory ring in parallel. In this manner, the CPU cores and co-processors may access slots as well as potential fields of the same slot of the shared memory ring in parallel to pull data stored in the ring describing jobs to be performed by the CPU cores and co-processors as the CPU cores and co-processors are available to perform the jobs.

The temporal ordering of the processed jobs is preserved by the shared memory ring. Therefore, although the CPU cores and co-processors may process and/or complete jobs that are associated with different slots of the memory ring in an order that is different from the temporal order of the incoming data packets, the correct ordering of outgoing, processed data packets corresponds to the ordering of the slots: an outgoing data packet having an associated lower slot number in the memory ring is transmitted to the network fabric before an outgoing data packet having an associated higher slot number.

In general, due to the shared memory ring being a circular array and having a predictable pattern of access, the shared memory ring may be CPU cache friendly.

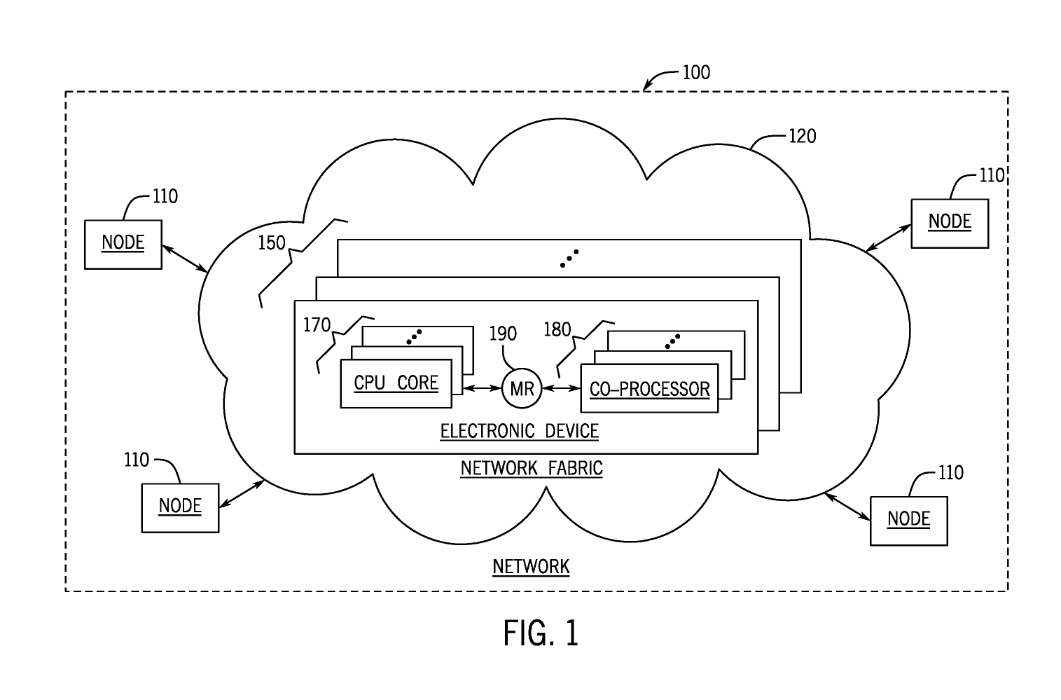

As a more specific example, FIG. 1 depicts a network 100 in accordance with example implementations. In general, the network 100 includes endpoint nodes 110 that may communicate over network fabric 120 via one or multiple electronic devices 150. In general, a given electronic device 150 facilitates the transmission of network packets between endpoint nodes 110 over the network fabric 120. In this regard, the electronic device 150 may perform various data packet processing tasks, or jobs, such as network protocol layer processing, encryption, decryption, compression, decompression, and so forth.

In accordance with example implementations, the electronic device 150 may be one of the endpoint nodes 110, part of one of the endpoint nodes 110, or a component of the network fabric 120 (as depicted in FIG. 1).

As described further herein, in accordance with example implementations, a given electronic device 150 may include a shared memory ring 190, one or multiple CPU cores 170 and one or multiple co-processors 180. The shared memory ring 190 allows packet processing-related jobs to be distributed among the CPU cores 170 and co-processors 180 in a manner that permits the CPU cores 170 and co-processors 180 to pull jobs from the shared memory ring 190 as the cores 170 and co-processors 180 become available to process the jobs. As described herein, the shared memory ring 190 allows parallel access to multiple slots of the shared memory ring 190 for such purposes as storing data describing data packets, storing data describing jobs to be performed on data packets, updating packet processing states, retrieving information for processed data packets, and so forth. Moreover, the ordering, or sequencing, of the slots of the shared memory ring 190 preserves the temporal order in which the network packets were received from the network fabric 120, so that the processed data packets may be transmitted to the network fabric 120 in the correct order, regardless of the order in which the packets are processed by the CPU cores 170 and co-processors 180.

In general, in accordance with example implementations, the endpoint node 110 may be any electronic device that is capable of providing or receiving network packets to/from the network fabric 120, including a server, a computer, a desktop computer, a smartphone, a workstation, a laptop computer, a notebook computer, a tablet computer, a mobile computing device, a wearable computing device, a network appliance, a web appliance, a distributed computing system, a processor-based system, and/or a consumer electronic device. In accordance with example implementations, a given endpoint node 110 may include such components as a processor, a memory, an input/output subsystem, data storage, communication circuitry, and so forth.

In general, the network fabric 120 may include any type of wired or wireless communication network, including cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), telephony networks, local area networks (LANs) or wide area networks (WANs), global networks (e.g., the Internet), or any combination thereof. Moreover, in accordance with example implementations, the network fabric 120 may include any number of network devices for purposes of facilitating communication between the nodes 110; and, in accordance with example implementations, one or multiple network devices may be or may contain the electronic device 150.

In general, the electronic device 150 may be any electronic device to facilitate wired and/or wireless network communications between endpoint nodes 110. As examples, in accordance with some implementations, the electronic device 150 may be a server (e.g., stand-alone, rack-mounted, blade, etc.), a router, a switch, a network hub, an access point, a storage device, a compute device, a multiprocessor system, a network appliance (e.g., physical or virtual), or any other computing device capable of processing network packets.

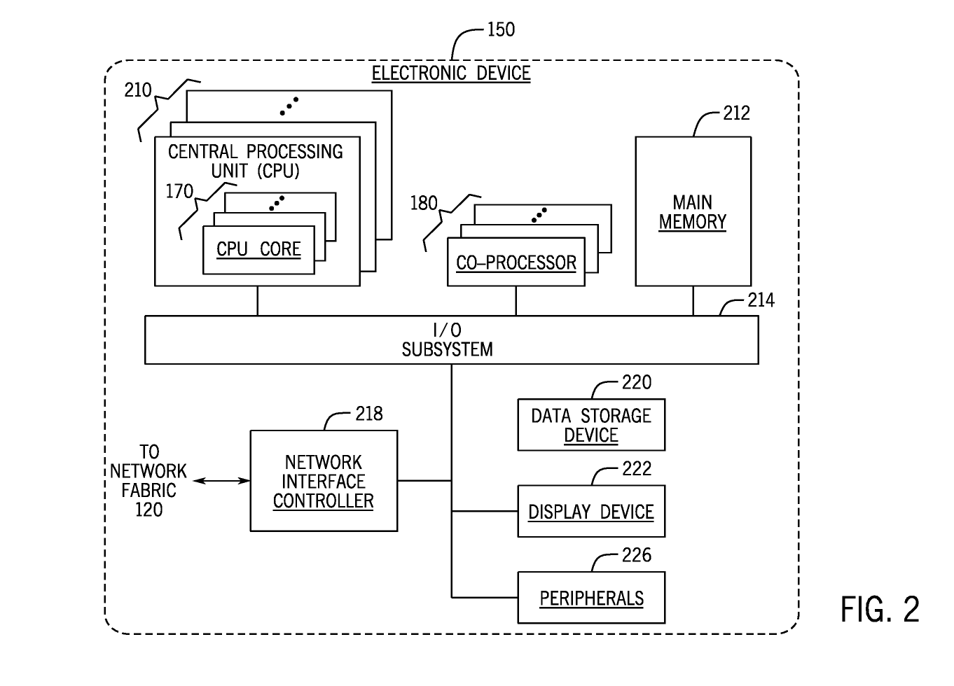

Referring to FIG. 2, in accordance with example implementations, the electronic device 150 may include one or multiple central processing units (CPUs) 210, one or multiple co-processors 180, a main memory 212, an input/output (I/O) subsystem 214, and one or multiple network interface controllers 218. In accordance with example implementations, the electronic device 150 may include one or multiple additional components, such as a data storage device 220, a display device 222, one or multiple peripherals 226, and so forth. In accordance with example implementations, one or more of the components depicted in FIG. 2 may be incorporated in, or otherwise form a portion of, another component. For example, in accordance with some implementations, the main memory 212, or portions thereof, may be incorporated into a CPU 210.

The CPU 210 may be embodied as any type of processor capable of performing the functions that are described herein. The CPU 210, depending on the particular implementation, may be a single core processor, a multi-core processor, a microcontroller, or other processor or processing/controlling circuit. For the example implementation of FIG. 2, the CPU 210 may contain one or multiple CPU cores 170.

In accordance with example implementations, the co-processor 180 is a processing unit that executes a reduced set of instructions, as compared to the instruction set of a general purpose processing unit, such as the CPU core 170. In general, the co-processor 180 is constructed to perform one or multiple specialized tasks in response to instructions that may collectively be an extension of a general purpose instruction set executed by the CPU core 170. As examples, a given co-processor 180 may be constructed to perform single instruction multiple data (SIMD) arithmetic operations, Fast Fourier Transform (FFT) operations, inverse FFT (IFFT) operations, cryptography operations, decompression and compression operations, floating point operations, and so forth. In accordance with example implementations, the particular job, or task, to be performed by a co-processor 180 is defined by a hardware descriptor. In this context, a “hardware descriptor” refers to one or multiple instructions within an instruction set of the co-processor 180, which causes the co-processor 180 to perform one or multiple functions. In accordance with example implementations, a CPU core 170 may not recognize a given hardware descriptor or, in general, be constructed to execute the corresponding instruction or instructions that are represented by the hardware descriptor.

In accordance with example implementations, one or multiple co-processors 180 and one or multiple CPU cores 170 may be part of a single integrated circuit package, and in accordance with further example implementations, the co-processors 180 may be part of one or multiple integrated circuit packages that are separate from the integrated package(s) that contain the CPU cores 170. Moreover, in accordance with example implementations, a given co-processor 180 may contain one or multiple processing cores that are constructed to execute the hardware descriptors, and in accordance with further example implementations, a given co-processor may be formed from hardware that is constructed to perform one or multiple specific functions, such as a field programmable gate array (FPGA), a General Purpose Graphics Processing Unit (GPGPU), an Application Specific Integrated circuit (ASIC), and so forth.

Depending in the particular implementation, the main memory 212 may contain volatile or non-volatile memory. In this manner, in accordance with example implementations, the memory 212 may store various data and software used during operation of the electronic device 150, such as ring data, packet data, stage data, operating systems, applications, programs, libraries, and drivers. In general, the memory 212 may be a non-transitory memory that may be formed from, as examples, semiconductor storage devices, memristors, magnetic storage devices, phase change memory devices, a 3D cross-point non-volatile memory (an Intel® Optane memory, for example), and so forth, depending on the particular implementation.

In accordance with example implementations, the memory 212 may store data and computer readable instructions (also called “software”) for purposes of implementing one or more of the stages and/or engines of the electronic device 150, which are described herein. In operation, the main memory 212 may store various data and machine executable instructions used during the operation of the electronic device 150, such as data for the shared memory ring 190, payload packet data, data associated with an operating system, data associated with an application, data representing a particular program, data associated with a library, data representing a driver, and so forth.

The I/O subsystem 214 may, in general, facilitate input/output operations with the CPU 210, the main memory 212, and other components of the electronic device 150. As examples, the I/O subsystem 214 may include memory controller hubs, input/output control hubs, integrated sensor hubs, firmware devices, communication links (i.e., point-to-point links, bus links, wires, cables, light guides, printed circuit board traces, etc.), and/or other components and subsystems to facilitate the input/output operations. In accordance with example implementations, the I/O subsystem 214 may form a portion of a system-on-a-chip (SoC) and be incorporated, along with one or more of the CPU 210, the main memory 212, and other components of the electronic device 150, on a single integrated circuit chip.

The network interface controller 218, in general, enables communications over the network fabric 120 between endpoint nodes 110. The network fabric 120 may be configured to use any one or more communication technology (e.g., wired or wireless communications) and associated protocols (e.g., Ethernet, Bluetooth®, Wi-Fi®, WiMAX, etc.) to effect such communication.

The network interface controller 218, in accordance with example implementations, may be contained on one or more add-in-boards, daughtercards, network interface cards, controller chips, chipsets, or other devices that may be used by the electronic device 150 to control or enhance communications between nodes 110. In accordance with example implementations, the network interface controller 218 may be a system-on-a-chip (SoC) that includes one or more processors, or included on a multichip package that also contains one or more processors. In accordance with example implementations, the network interface controller 218 may include one or multiple local processors (not shown) and/or a local memory (not shown), which are local to the controller 218. In accordance with example implementations, the local processor of the network interface controller 218 may be capable of performing one or more functions of the electronic device 150, as described herein. In accordance with example implementations, the network interface controller 218 may be an intelligent network interface controller that contains processors and/or co-processors, which perform packet processing activities and may perform one or more functions of the electronic device 150, as described herein. In accordance with example implementations, the local memory of the network interface controller 218 may be integrated into one or more components of the electronic device 150 at the board level, socket level, chip level, and/or other levels. Moreover, in accordance with example implementations, the network interface controller 218 may be a host fabric interface (an Intel® Omni-Path host fabric interface, for example).

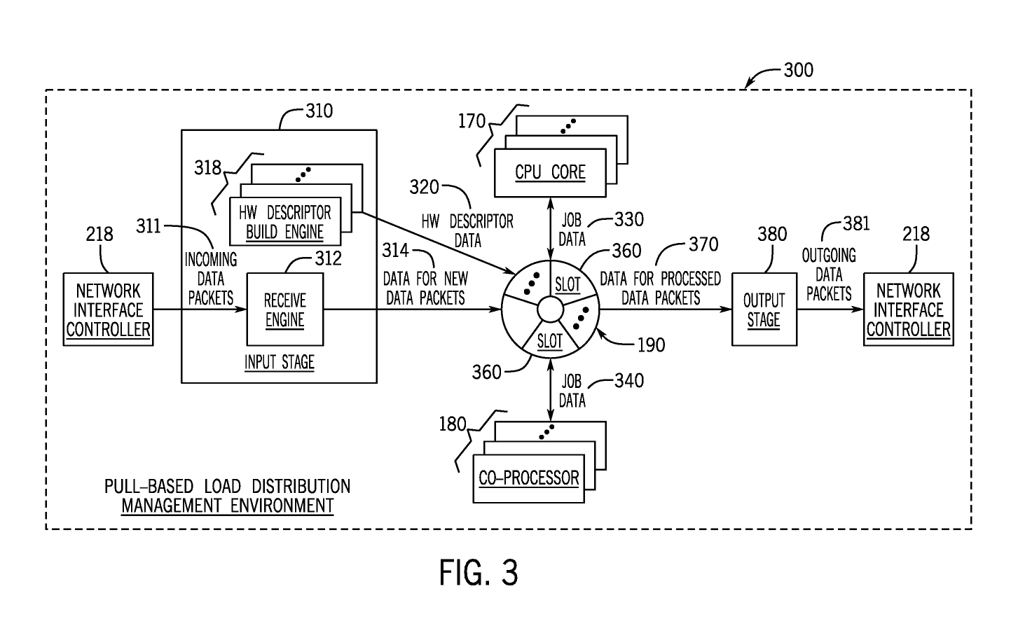

Referring to FIG. 3, in accordance with example implementations, a given electronic device 150 may establish a pull-based load distribution management environment 300 during operation. In particular, in accordance with example implementations, in addition to the components described above, such as the shared memory ring 190, the network interface controller 218, the co-processors 180 and the CPU cores 170, the electronic device 150 may include an input stage 310 (that includes one or multiple hardware descriptor build engines 318 and a receive engine 312) and an output stage 380. Depending on the particular implementation, any of the input receive engine 312, hardware descriptor build engine 318, input stage 310 or output stage 380 may be implemented by a general purpose computer executing machine executable instructions or a specifically-defined hardware circuit (an Application Specific Integrated Circuit (ASIC), a field programmable gate array (FPGA), and so forth).

The input stage 310 of the electronic device 150 receives data packets 311 to be processed from the network interface controller 218. As a specific example, the data packets 311 may be packets that are received from one or multiple ports of the network interface controller 218. The input stage 310, in accordance with example implementations, processes the data packets 311 to store data 314 for each data packet in a slot 360 of the memory ring 190.

More specifically, in accordance with example implementations, the data (also called “slot data” herein) 314 that is stored by the input stage 312 in a given slot 360 may include metadata, which, in general, describes the associated data packet. In this manner, the metadata may contain such information as data representing the packet size, a packet state (a state indicating whether the packet has been processed, is being processed or is waiting to be processed, for example), the network port that received the packet, the network port that is to transmit the packet after processing, the linking of buffers into larger packets, the job or jobs to be performed on the packet, and so forth. In accordance with example implementations, the data 314 may also include data representing a packet data reference, or pointer. In this manner, the pointer points to an address, or buffer, where the payload data for the network packet is stored.

The data 314 is stored in a corresponding slot 360 of the shared memory ring 190. In this manner, the shared memory ring 190 includes a predetermined number of slots 360 which may be a power of two, in accordance with example implementations. The slots 360 have associated indices such that a given slot 360 may be referenced by its associated index. In accordance with example implementations, the slots 360 are indexed according to an incrementing and wrapping slot sequence number. In other words, the slots 360 are assigned corresponding indexes 0, 1, 2, . . . N-1, where “N” represents the number of slots 360 of the shared memory ring 190; and incrementing the N-1 index wraps back to index 0.

In accordance with example implementations, the slot index corresponds to the temporal order of the incoming data packets, e.g., the packet associated with slot index 4 was received before the packet associated with slot index 5. The output stage 380 of the electronic device 150 may use this indexing of the slots 360 for purposes of assembling processed data packets 314 for transmission from the electronic device 150 in a manner that preserves the temporal order of the incoming data packets 311.

In accordance with example implementations, the receive engine 312 of the input stage 310 uses an input sequence number to identify which slot 360 of the shared memory ring 190 is to store the data 314 for a given incoming data packet. In this manner, in response to receiving an incoming data packet 311 for a given network port, the receive engine 312 may generate data 314 describing metadata and a pointer reference for the data packet, write to the memory ring 190 to store the data 314 in a slot 360 indexed by the input sequence number, and thereafter, update the input sequence number, such as, for example, incrementing the input sequence number.

In accordance with example implementations, the input stage 310 performs the following modulus operation to identify a particular slot 360 based on the input sequence number: (input sequence number of next free slot) mod (number of slots of memory ring 190)=slot index of memory ring 190.

The data 314 may, in accordance with some implementations, contain metadata that describes one or multiple jobs to be performed on the associated packet, and this metadata be sufficient to describe the job for processing by a CPU core 170. However, in accordance with some implementations, a given packet may be processed by a co-processor 180, and as such, the input stage 310 adds hardware descriptors, which describe specific co-processor instructions, to the slot data. In general, a hardware descriptor refers to one or multiple instructions in a particular co-processor format, which may be executed by a co-processor 180 to perform a certain function (a cryptography, compression, or decompression function, as examples) on the data packet.

In accordance with some implementations, the hardware descriptor build engines 318 are constructed to provide hardware descriptors 320 for, as examples, associated co-processor classes, specific co-processors, specific co-processor jobs, and so forth.

After being processed by the CPU cores 170 and co-processors 180, the corresponding processed data packets may be assembled by the output stage 380 and forwarded to the network interface controller 218 for transmission via their associated outgoing ports to the network fabric 120. In this manner, in accordance with example implementations, the output stage 380 retrieves data 370 for processed data packets from the slots 360 in accordance with an output sequence number. In this manner, a given value for the output sequence number identifies the slot number for the next processed data packet to be assembled and communicated to the network interface controller 218.

In accordance with example implementations, the output stage 310 performs the following modulus operation to identify a particular slot 360 based on the output sequence number: (output sequence number of next slot) mod (number of slots of memory ring 190)=slot index of memory ring 190.

In accordance with example implementations, the output stage 380 may read the current value for the output sequence number; determine from a comparison of the values of the output sequence number and the input sequence number whether the shared memory ring 190 is empty (i.e., determines whether the output sequence number value is greater than the input sequence number value); and if the shared memory ring 190 is not empty, the output stage 380 reads the data from the slot 360 indexed by the output sequence number (as described by the modulus function above) and reads the associated payload data. The output stage 380 then assembles the packet, forwards the packet to the network interface controller 218 for transmission to the associated port and updates (increments, for example) the output sequence number.

The workers, i.e., the CPU cores 170 and co-processors 180, which process the data packets associated with the slots 360 of the shared memory ring 190, in accordance with example implementations, do not consume the data in the memory ring 190. Rather, in accordance with example implementations, the data stored in the slots 360 remains until overwritten. In other words, there is no end pointer, in accordance with example implementations. In general, due to the array being a circular array and having a predictable pattern of access, the memory ring 190 may be CPU cache friendly.

In accordance with example implementations, the CPU cores 170 and co-processors 180 are workers, and a given worker, in general, may access a given slot 360, process the data packet associated with the slot 360 based on a job described by the slot data, and after completing processing the data packet, store data in the slot 360 representing or indicating that processing of the data packet by the worker is complete. In accordance with example implementations, each worker may maintain an associated worker sequence number, which represents the particular slot 360 being processed/accessed by the worker. In this manner, a given worker reads the input sequence number and compares the input sequence number to its associated worker sequence number to determine whether there are any new packets to be processed. Alternatively, in accordance with example implementations, a worker may read the metadata of the next slot 360 of the shared memory ring 190 (i.e., employs a peek ahead technique) to see if the metadata packet state indicates that the packet entry is ready to be processed. In accordance with example implementations, if there is a new data packet to be processed, the worker reads the metadata from the slot 360 associated with the current value of the worker's number. The worker may then decide if the packet should be processed or bypassed.

In accordance with example implementations, the worker performs the following modulus operation to identify a particular slot 360 based on its associated worker sequence number: (worker sequence number) mod (number of slots of memory ring 190)=slot index of memory ring 190.

In accordance with example implementations, the workers apply a collaborative set of rules for purposes of distributing the packet processing jobs among the workers. For example, in accordance with example implementations, the worker may apply a collaborative rule that causes the worker to check a state variable in the metadata or modulo (N) of the worker's sequence number to determine whether this instance of the worker should operate on the associated data packet associated with a given slot number 360. As a more specific example, there may be 1 to NUM workers, and the particular consumer may be the current sequence number mod NUM. If the worker decides that the data packet should be processed, then the worker performs the job indicated by the slot's metadata, i.e., performs the indicated operation; and then, the consumer updates the metadata by writing to the slot 360. Otherwise, if the worker decides that the associated data packet is not to be processed, the worker may do nothing and wait for the next data packet to process. Regardless, of the result of applying the collaborative rule, the worker may then update the worker's local sequence number.

As another example of the collaborative rules, the co-processor 180 and CPU cores 170 may select jobs to operate on based on fields in the slot data. In this manner, in accordance with example implementations, the co-processors 180 and CPU cores 170 may have the rules that select a given job based on such factors as the length of the packet (in bytes, for example), the source Internet Protocol (IP) address, a virtual local area network (VLAN) identifier, and so forth.

As another example of the collaborative rules, on accordance with further example implementations, the co-processors 180 and CPU cores 170 may claim one or multiple contiguous slots 360 (i.e., slots 360 associated with a contiguous range of slot sequence numbers) using a predetermined claim function. Thus, many implementations are contemplated, which are within the scope of the appended claims.

Regardless of the particular collaborative rules that are employed, the rules are constructed so that the CPU cores 170 and co-processor 180 always select different jobs. For example, the CPU cores 170 may select packets having a packet length less than or equal to 256 bytes, whereas a job associated with a packet length greater than 256 bytes may be selected by a co-processor 180.

In accordance with example implementations, multiple workers may process separate fields in a given slot 360, i.e., multiple co-processors 180 may process different jobs on the same data packet. This processing may be in parallel or may be sequential in nature. For example, a first co-processor 180 may, for example, perform processing of a given data packet according to a first job, and when this processing is complete, the first co-processor 180 may update a field (a done field, for example) of the slot 360 to allow a second co-processor 180 to further process the data packet according to a second job. As another example, multiple co-processors 180 may process multiple jobs for the same data packet, for the scenario in which the jobs are independent, i.e., the processing results of one job do not affect the processing results of the other job.

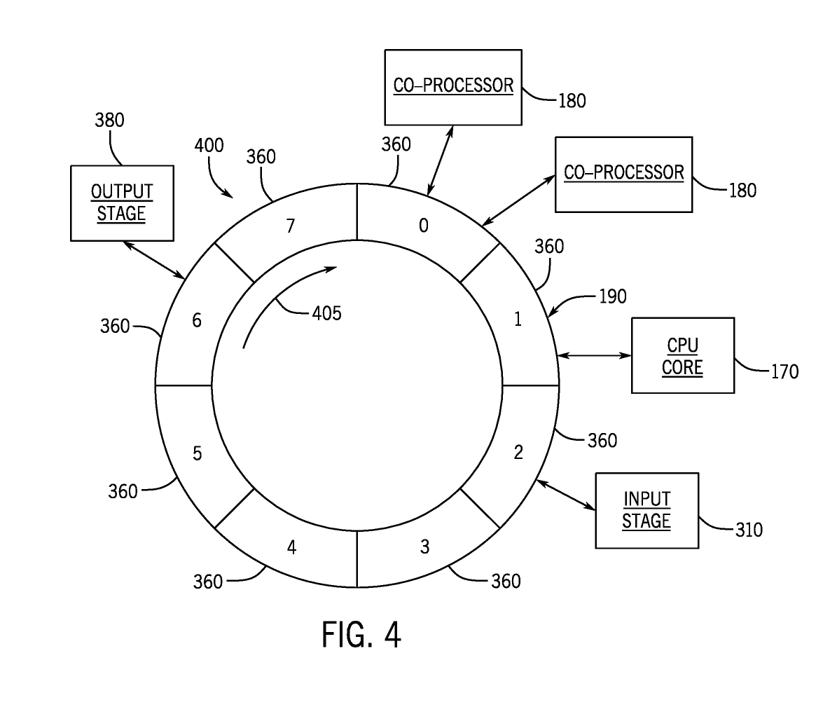

FIG. 4 depicts an example scenario in which the shared memory ring 190 is populated by entries by the input stage 310, contains data in slots 360 processed by multiple workers, such as a co-processor 180 processing a packet associated with a slot 360 having the number “0” in FIG. 4; and a co-processor 180 that, as depicted in FIG. 4, also processes the data packet associated with the slot 360 associated with the number “0.” In this manner, the two co-processors 180 may process the data packet associated with the slot in parallel or in an interleave fashion. Moreover, FIG. 4 depicts the CPU core 170 processing a data packet associated with the slot number 1. Moreover, as depicted in FIG. 4, the input stage 310 has an input sequence number pointing to the slot 2, whereas the output stage 380 has an output sequence number pointing to the slot 6. Moreover, as shown in FIG. 4, the slots 360 of the memory ring 190 are circular in nature and preserve a temporal order 405. Therefore, regardless of the particular order in which the packets associated with the slots 360 are processed, the input stage 310 and output stage 380 conform to the temporal order 405 so that outgoing data packets may be reassembled in the correct order, regardless of the order in which the consumers process the associated data slots.

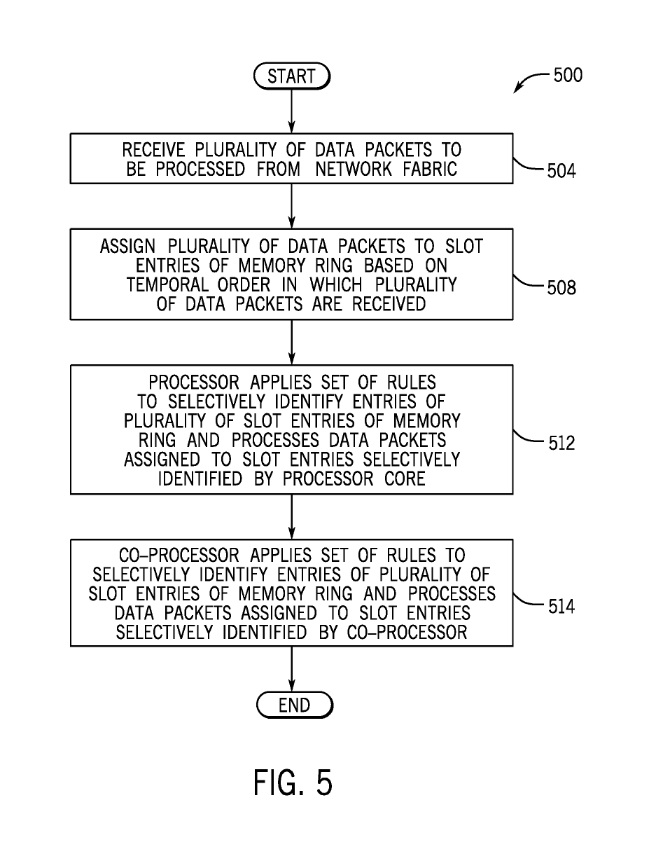

Thus, referring to FIG. 5, in accordance with example implementations, a technique 500 for balancing load distribution among at least one co-processor and at least one CPU core includes receiving (block 504) a plurality of data packets to be processed from network fabric and assigning (block 508) the plurality of data packets to slot entries of a memory ring based on a temporal order in which the plurality of data packets are received. The technique 500 includes a processor core applying (block 512) a set of rules to selectively identify entries of the plurality of slot entries of the memory ring and processing data packets assigned to the slot entries that are selectively identified by the processor core. The technique 500 includes a co-processor applying (block 514) the set of rules to selectively identify entries of the plurality of slot entries of the memory ring and processing data packets assigned to the slot entries that are selectively identified by the co-processor.

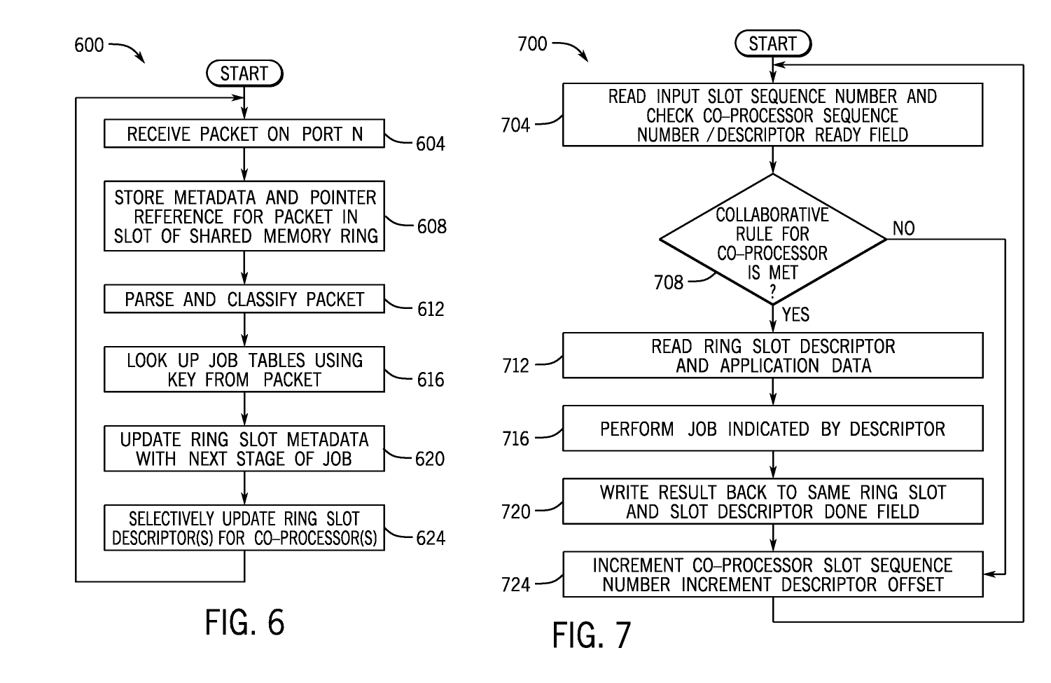

Referring to FIG. 3 in conjunction with FIG. 6, in accordance with example implementations, the receive engine 312 may perform a technique 600 that includes receiving (block 604) a packet on a given port N and sharing (block 608) metadata and a pointer reference for the packet in a slot of a shared memory ring. The technique 600 includes the receive engine 312 parsing and classifying the packets pursuant to block 608 and retrieving, or looking up, job tables using a key for the packet, pursuant to block 616. The receive engine 312 may then update (block 620) the ring slot metadata stored in the slot 360 so that the metadata describes the next stage of the job to be performed (compression, a cryptographic function, and so forth, as examples). The receive engine 312 may then update ring descriptors for co-processors, as depicted in block 624.

Referring to FIG. 7 in conjunction with FIG. 3, in accordance with example implementations, a co-processor 180 may perform a technique 700 that includes, as depicted in block 704, reading an input slot sequence number and checking the co-processor's sequence number; or checking whether a descriptor ready field is set in a given slot 360. Next, pursuant to decision block 708, the co-processor 180 determines, or checks whether a collaborative rule for the co-processor has been met. In this manner, the rule may include determining whether, for example, the memory ring 190 is empty and/or determining whether, based on a collaborative rule whether the co-processor 180 should process the packet associated with the slot 360. Next, pursuant to block 712, if the result of decision block 708 means that the co-processor 180 processes the packet associated with the slot 360, then the co-processor reads (block 712) the ring slot descriptor and the application data and performs (block 716) the job indicated by the ring slot descriptor (encryption, compression, as examples). The co-processor 180 then writes (block 720) the result back to the ring slot and sets the descriptor done field (to indicate completion of the job) before incrementing (block 724) the co-processor slot sequence number or incrementing descriptor offset (whichever is applicable).

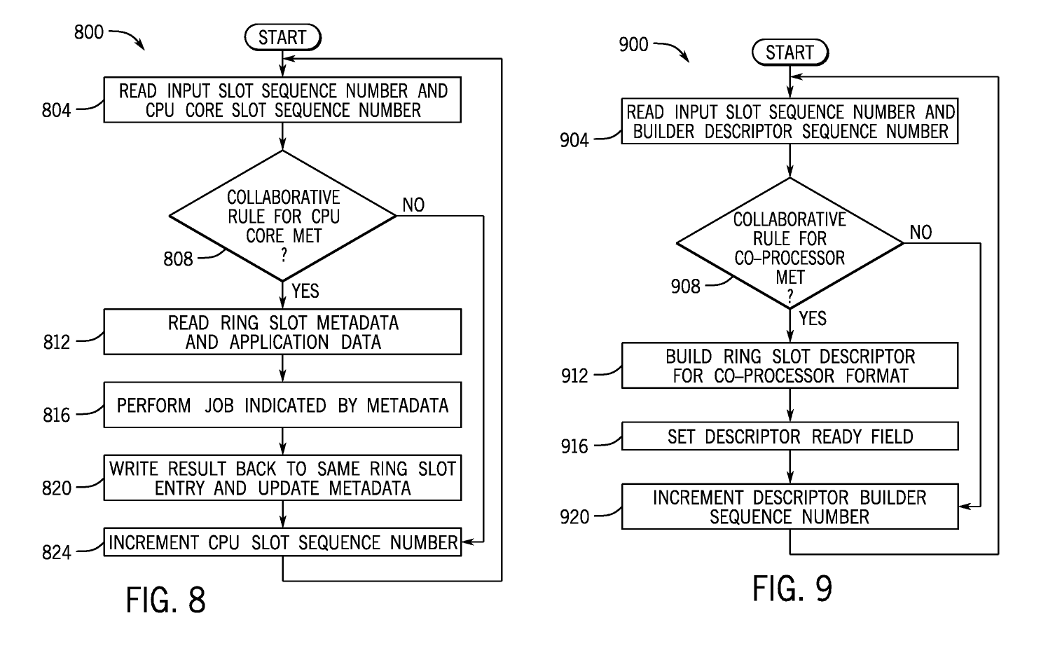

Referring to FIG. 8 in conjunction with FIG. 3, in accordance with example implementations, a CPU core 170 may perform a technique 800 that includes reading (block 804) the input slot sequence number and determining, or checking, the CPU core slot sequence number. If a determination is made (decision block 808) that the ring is not empty and the collaborative rules indicate that the CPU core 170 is to process the packet associated with the slot 360, then, pursuant to block 812, the CPU core 170 reads the ring slot metadata and application data. Pursuant to block 816, the CPU 170 core then performs the job indicated by the metadata, writes the result back to the same ring slot entry and updates the metadata, pursuant to block 820. The CPU core then increments (block 824) the sequence number for the CPU core current slot.

Referring to FIG. 9 in conjunction with FIG. 3, in accordance with example implementations, the hardware descriptor build engine 318 performs a technique 900 that is depicted in FIG. 9. Pursuant to the technique 900, the hardware descriptor build engine 318 reads (block 904) the input slot sequence number and checks the descriptor build sequence number. If the hardware descriptor build engine 318 determines (decision block 908) that the collaborative rule for the co-processor is met, i.e., determines that the associated data packet is to be processed by one of the co-processors 180, then the technique 900 includes the hardware descriptor build engine 318 building (block 912) the ring slot descriptor for the co-processor format. Next, the technique 900 includes the hardware descriptor build engine 318 setting (block 920) the descriptor ready status of the metadata and incrementing (block 924) the descriptor build sequence number.

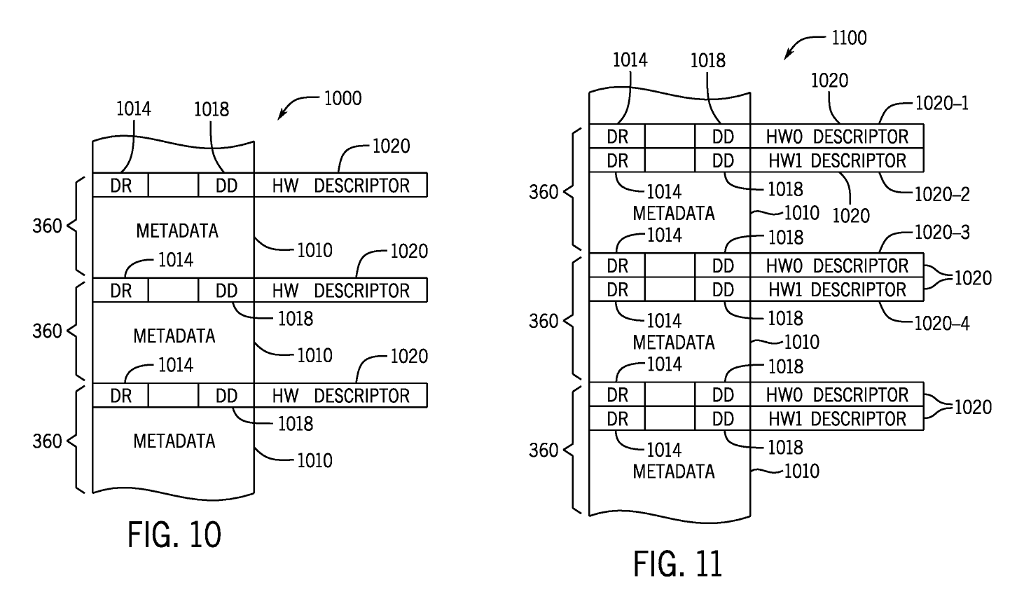

FIG. 10 is an illustration 1000 of the data stored in slots 360 that are processed by co-processors 180 for the case in which a single co-processor 180 processes each data packet. In this manner, FIG. 10 depicts each slot 360 being associated with metadata 1010 describing the packet state and pointer reference, hardware descriptors 1020 describing specific aspects of the job to be performed by the co-processor 180 in accordance with the processor's instruction format; a descriptor ready field 1014, which is set to indicate when data in the slot 360 is ready to be processed by a co-processor 180; and a descriptor done field 1018 that is set by the co-processor 180 when the co-processor processes the hardware descriptor 1020.

FIG. 11 depicts an example illustration 1100 for the case in which multiple co-processors 180 process a given packet. In this manner, FIG. 11 depicts a slot 360 in which the slot contains multiple hardware descriptors 1020-1 and 1020-2, where each hardware descriptor 1020-1 and 1020-2 is associated with the processing by a different co-processor 180. In this manner, the hardware descriptor 1020-1 is associated with descriptor ready 1014 and descriptor done 1018 fields; and in a similar manner, the hardware descriptor 1020-2 is associated with descriptor ready 1014 and descriptor done 1018 fields. In this manner, depending on the particular processing being done, the two co-processors 180 processing the associated data packet may process the descriptors sequentially or in parallel. In a similar manner, FIG. 11 depicts hardware descriptors 1020-3 and 1020-4 of the next slot. Although FIG. 11 depicts two hardware descriptors per slot 360, in accordance with further example implementations, a given slot 360 may contain more than two hardware descriptors, i.e., a given data packet may be processed by more than two co-processors. Thus, many implementations are contemplated, which are within the scope of the appended claims.

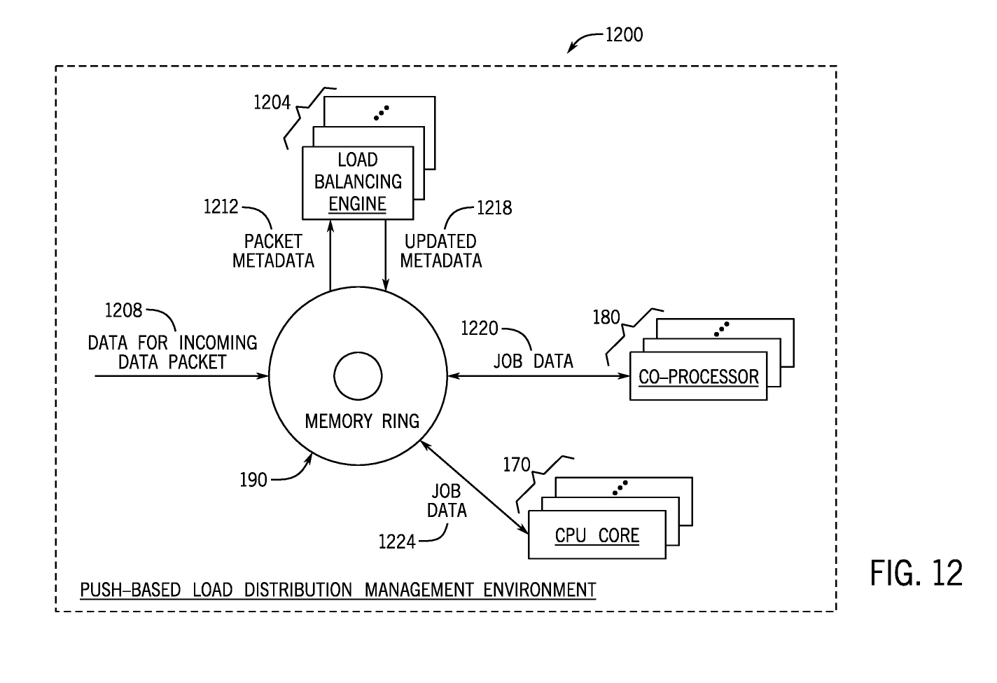

Although a pull-based load distribution scheme is described herein in connection with a shared memory ring, in accordance with further example implementations, a workload may be distributed among co-processors and CPU cores using a shared memory ring and a push-based scheme. For example, referring to FIG. 12, in accordance with some implementations, an electronic device may have one or multiple load balancing engines 1204 that are part of a load distribution management environment 1200. In these implementations, the load balancing engine 1204 may read data from slots of a memory ring 190 (i.e., retrieve packet metadata 1212) and select which CPU core 170 or co-processor 180 should process the job. The load balancing engine 1204 may then update the metadata (1218) based on rules applied by the load balancing engine 1204. Using this technique, the load balancing engine 1204 implements a push-type load distribution in that the load balancing engine 1204 decides which worker processes a given packet.

A particular advantage of this technique is that the load balancing engines 1204 may be used to steer ring slots to particular CPU cores 170 or co-processors 180, which may help interwork with existing co-processors 180 that have hardware limitations on which job the co-processors 180 may process, such as, for example, limits on the packet sizes that are supported by the co-processors 180. This allows legacy devices to still work with the shared memory ring 190, without modifying the co-processors 180. In this manner, other aspects of the shared ring, i.e., the temporal order of the ring 190, the concurrent access by multiple workers, and so forth, as described herein, may still be employed. Other advantages may include avoiding overloading of relatively low capacity legacy devices by having the load balancing engine 1204 receiving feedback from a given co-processor 180 and adapting the number of jobs that are steered to the co-processor 180.

In general, a given load balancing engine 1204 may be formed from dedicated hardware or may be formed from a general purpose processor (one of the CPU cores 170, for example) executing machine executable instructions.

### EXAMPLES

Illustrative examples of the technologies disclosed herein are provided below. An embodiment of the technologies may include any one or more, and any combination of, the examples described below.

Example 1 includes an apparatus that includes a processor, a co-processor and a memory ring. The memory ring includes a plurality of slots that are associated with a plurality of jobs. The processor is to apply a set of rules and based on the application of the set of rules, selectively access a first slot of the plurality of slots to read first data stored in the first slot representing a first job of the plurality of jobs and process the first job based on the first data. The co-processor is to apply the set of rules and based on the application of the set of rules, access a second slot of the plurality of slots other than the first slot to read second data representing a second job of the plurality of jobs and process the second job based on the second data.

Example 2 includes the subject matter of Example 1 and wherein the processor and the co-processor to process the associated data packets in respective overlapping time intervals.

Example 3 includes the subject matter of any of Examples 1-2 and further including an output stage to access the memory ring to retrieve results that are associated with the processing of the first and second jobs in an order that is consistent with the temporal order.

Example 4 includes the subject matter of any of Examples 1-3 and wherein the co-processor to determine whether the co-processor is to perform processing of the second job based on a slot index derived by applying the set of rules.

Example 5 includes the subject matter of any of Examples 1-4 and wherein the co-processor to determine whether the co-processor is to perform processing of the second job based on the second data.

Example 6 includes the subject matter of any of Examples 1-5 and wherein the co-processor to process job data associated with the second job based on a pointer to the job data represented by the second data.

Example 7 includes the subject matter of any of Examples 1-6 and wherein the second slot to further store third data representing a third job of the plurality of jobs, and the co-processor to read the second data including a first co-processor to read the second data; and the apparatus further including a second co-processor to access the second slot to read the third data and selectively process the third job based on the third data.

Example 8 includes the subject matter of any of Examples 1-7 and wherein the second co-processor is to process the third job based on the third data representing completion of the processing of the second job by the first co-processor.

Example 9 includes the subject matter of any of Examples 1-8 and includes the first co-processor and the second co-processor is to process the second and third jobs in respective overlapping time intervals.

Example 10 includes the subject matter of any of Examples 1-9 and further including a fabric interface controller to receive a plurality of data packets to be processed. Each slot of the plurality of slots is associated with a data packet of the plurality of data packets; the first job is associated with processing a first data packet of the plurality of data packets; and the second job is associated with processing a second data packet of the plurality of data packets.

Example 11 includes the subject matter of any of Examples 1-10 and further including an input stage to use a slot sequence number to identify a slot of the plurality of slots in which to store metadata associated with a given data packet of the plurality of data packets in response to the fabric interface controller receiving the given data packet; and store metadata describing the given data packet in the identified slot.

Example 12 includes the subject matter of any of Examples 1-11 and including the metadata representing at least one of a packet size, a packet state, a port receiving the first data packet, or a port to transmit the data packet after processing.

Example 13 includes the subject matter of any of Examples 1-12 and including the input stage to further store data in the identified slot representing a pointer to payload data associated with the given data packet.

Example 14 includes the subject matter of any of Examples 1-13 and including the co-processor to process the data packet according to the second job and write to the memory ring to modify the entry associated with the second slot in response to the co-processor completing processing of the second data packet.

Example 15 includes the subject matter of any of Examples 1-14 and further including a load balancing stage to write metadata to the second slot designating the co-processor to perform processing of the second job.

Example 16 includes the subject matter of any of Examples 1-15 and further including the plurality of slots being ordered corresponding to a temporal order in which the first data and the second data are stored in the memory ring, and the processor and the co-processor are to access the first slot and the second slot and process the first job and the second job in an order that is independent of the temporal order.

Example 17 includes the subject matter of any of Examples 1-16, and further including the memory ring including a lockless ring to be shared in parallel accesses by the processor and the co-processor.

Example 18 includes at least one non-transitory machine-readable storage medium that has stored thereon instructions that, when executed by at least one machine, cause the at least one machine to perform operations that include receiving a plurality of data packets to be processed from network fabric; assigning the plurality data packets to slot entries of a memory ring based on a temporal order in which the plurality of data packets are received; a processor core applying a set of rules to selectively identify entries of the plurality of slot entries of the memory ring and processing data packets assigned to the slot entries selectively identified by the processor core; and a co-processor applying the set of rules to selectively identify entries of the plurality of slot entries of the memory ring and processing data packets assigned to the slot entries selectively identified by the co-processor.

Example 19 includes the subject matter of Example 18, and the medium storing instructions that when executed by the at least one machine cause the at least one machine to, for a first data packet of the plurality of data packets, determine whether the memory ring is full based at least in part on comparison of an input slot sequence number to an output slot sequence number; and based at least in part on a result of the comparison, selectively assign the first data packet to a slot of the plurality of slots represented by a value of the input slot sequence number.

Example 20 includes the subject matter of any of Examples 18-19, and the medium storing instructions that executed by the at least one machine cause the at least one machine to, for a first data packet of the plurality of data packets, store metadata representing completion of processing of the first data packet in the slot assigned to the first data packet.

Example 21 includes the subject matter of any of Examples 18-20, and the medium storing instructions that when executed by the at least one machine cause the at least one machine to identify a slot of the plurality of slots based at least in part on an output slot sequence number; and read metadata from the identified slot based at least in part on the output slot sequence number to determine whether the data packet associated with the identified slot has been processed.

Example 22 includes the subject matter of any of Examples 18-21, and medium storing instructions that when executed by the at least one machine cause the at least one machine to perform operations including the co-processor processing a first data packet based on data contained in a first field of a first slot of the plurality of slots; and another co-processor processing the first data packet based on data contained in a second field of the first slot.

Example 23 includes the subject matter of any of Examples 18-22 and wherein at least part of the processing of the first data packet based on the data contained in the first field and the processing of the first data packet based the data contained in the second field occurring in parallel.

Example 24 includes the subject matter of any of Examples 18-23 and wherein at least part of the processing of the first data packet based on the data contained in the first field and the processing of the first data packet based the data contained in the second field occurring sequentially.

Example 25 includes an apparatus that includes one or more processor cores; one or more co-processors; and a memory. The memory has stored thereon a plurality of instructions that when executed by the one or more processor cores and the one or more co-processors causes the one or more processor cores and the one or more co-processors to receive a plurality of data packets to be processed from network fabric; assign the plurality data packets to slot entries of a memory ring based on a temporal order in which the plurality of data packets are received; apply a set of rules to selectively identify entries of the plurality of slot entries of the memory ring to be processed by the one or more processor cores; and apply the set of rules to selectively identify entries of the plurality of slot entries of the memory ring to be processed by the one or more co-processors.

Example 26 includes the subject matter of Example 25 and wherein at least one processor core of the one or more processor cores and at least one co-processor of the one or more co-processors process data packets that are assigned to different slot entries of the memory ring in respective overlapping time intervals.

Example 27 includes a method that includes receiving a plurality of data packets to be processed from network fabric; assigning the plurality data packets to slot entries of a memory ring based on a temporal order in which the plurality of data packets are received; a processor core applying a set of rules to selectively identify entries of the plurality of slot entries of the memory ring and processing data packets assigned to the slot entries selectively identified by the processor core; and a co-processor applying the set of rules to selectively identify entries of the plurality of slot entries of the memory ring and processing data packets assigned to the slot entries selectively identified by the co-processor.

Example 28 includes the subject matter of Example 27 and wherein assigning the data packets to slot entries of a memory ring includes, for a first data packet of the plurality of data packets, determining whether the memory ring is full based at least in part on comparison of an input slot sequence number to an output slot sequence number; and based at least in part on a result of the comparison, selectively assigning the first data packet to a slot of the plurality of slots represented by a value of the input slot sequence number.

Example 29 includes the subject matter of any of Examples 27-28 and wherein the processor core processing data packets assigned to the slot entries selectively identified by the processor core includes, for a first data packet of the plurality of data packets, storing metadata representing completion of processing of the first data packet in the slot assigned to the first data packet.

Example 30 includes the subject matter of any of Examples 27-29 and wherein the co-processor processing data packets assigned to the slot entries selectively identified by the co-processor includes for a first data packet of the plurality of data packets, storing metadata representing completion of processing of the first data packet in the slot assigned to the first data packet.

Example 31 includes the subject matter of any of Examples 27-30 and further including preparing processing packets for transmission to the network fabric, including identifying a slot of the plurality of slots based at least in part on an output slot sequence number; and reading metadata from the identified based at least in part on the output slot sequence number to determine whether the data packet associated with the identified slot has been processed.

Example 32 includes the subject matter of any of Examples 27-31 and further including the co-processor processing a first data packet based on data contained in a first field of a first slot of the plurality of slots; and another co-processing processing the first data packet based on data contained in a second field of the first slot.

Example 33 includes the subject matter of any of Examples 27-32 and wherein at least part of the processing of the first data packet based on the data contained in the first field and the processing of the first data packet based the data contained in the second field occurring in parallel.

Example 34 includes the subject matter of any of Examples 27-33 and wherein at least part of the processing of the first data packet based on the data contained in the first field and the processing of the first data packet based the data contained in the second field occurring sequentially.

Example 35 includes an apparatus including means for assigning a plurality of data packets received from a network fabric to slot entries of a memory ring based on a temporal order in which the plurality of data packets are received; a processor core applying a set of rules to selectively identify entries of the plurality of slot entries of the memory ring and processing data packets assigned to the slot entries selectively identified by the processor core; and a co-processor applying the set of rules to selectively identify entries of the plurality of slot entries of the memory ring and processing data packets assigned to the slot entries selectively identified by the co-processor.

Example 36 includes the subject matter of Example 35 and further including means for determining, for a first data packet of the plurality of data packets, whether the memory ring is full based at least in part on comparison of an input slot sequence number to an output slot sequence number; and means for selectively assigning the first data packet to a slot of the plurality of slots represented by a value of the input slot sequence number based at least in part on a result of the comparison.

Example 37 includes the subject matter of any of Examples 35-36 and further including means for storing, for a first data packet of the plurality of data packets, metadata representing completion of processing of the first data packet in the slot assigned to the first data packet.

Example 38 includes the subject matter of any of Examples 35-37 and further includes means for identifying a slot of the plurality of slots based at least in part on an output slot sequence number; and means for reading metadata from the identified slot based at least in part on the output slot sequence number to determine whether the data packet associated with the identified slot has been processed.

Example 39 includes the subject matter of any of Examples 35-38 and wherein the co-processor processes a first data packet based on data contained in a first field of a first slot of the plurality of slots; and another co-processor processes the first data packet based on data contained in a second field of the first slot.

Example 40 includes the subject matter of any of Examples 35-39 and wherein at least part of the processing of the first data packet based on the data contained in the first field and the processing of the first data packet based the data contained in the second field occur in parallel.

Example 41 includes the subject matter of any of Examples 35-40 and wherein at least part of the processing of the first data packet based on the data contained in the first field and the processing of the first data packet based the data contained in the second field occur sequentially.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. An apparatus comprising:
a processor;
a co-processor; and
a memory ring comprising a plurality of slots associated with a plurality of jobs;
the processor is to apply a set of rules and based on the application of the set of rules, selectively access a first slot of the plurality of slots to read first data stored in the first slot representing a first job of the plurality of jobs and process the first job based on the first data; and
the co-processor is to apply the set of rules and based on the application of the set of rules, access a second slot of the plurality of slots other than the first slot to read second data representing a second job of the plurality of jobs and process the second job based on the second data.

2. The apparatus of claim 1, wherein the processor and the co-processor to process the first and second jobs in respective overlapping time intervals.

3. The apparatus of claim 1, further comprising:
an output stage to access the memory ring to retrieve results associated with the processing of the first and second jobs in an order consistent with the temporal order.

4. The apparatus of claim 1, wherein the co-processor to determine whether the co-processor is to perform processing of the second job based on a slot index derived by applying by the set of rules.

5. The apparatus of claim 1, wherein the co-processor to determine whether the co-processor is to perform processing of the second job based on the second data.

6. The apparatus of claim 1, wherein the co-processor to process job data associated with the second job based on a pointer to the job data represented by the second data.

7. The apparatus of claim 1, wherein the second slot to further store third data representing a third job of the plurality of jobs, and the co-processor to read the second data comprises a first co-processor to read the second data, the apparatus further comprising:
a second co-processor to access the second slot to read the third data and selectively process the third job based on the third data.

8. The apparatus of claim 7, wherein the second co-processor to process the third job based on the third data representing completion of the processing of the second job by the first co-processor.

9. The apparatus of claim 7, wherein the first co-processor and the second co-processor to process the second and third jobs in respective overlapping time intervals.

10. The apparatus of claim 1, further comprising:
a fabric interface controller to receive a plurality of data packets to be processed;
each slot of the plurality of slots is associated with a data packet of the plurality of data packets;
the first job is associated with processing a first data packet of the plurality of data packets; and
the second job is associated with processing a second data packet of the plurality of data packets.

11. The apparatus of claim 10, further comprising an input stage to:
use a slot sequence number to identify a slot of the plurality of slots in which to store metadata associated with a given data packet of the plurality of data packets in response to the fabric interface controller receiving the given data packet; and
store metadata describing the given data packet in the identified slot.

12. The apparatus of claim 11, wherein the metadata represents at least one of a packet size, a packet state, a port receiving the given data packet, or a port to transmit the given data packet after processing.

13. The apparatus of claim 11, wherein the input stage to further store data in the identified slot representing a pointer to payload data associated with the given data packet.

14. The apparatus of claim 10, wherein the co-processor to process the second data packet according to the second job and write to the memory ring to modify data stored in the second slot in response to the co-processor completing processing of the second data packet.

15. The apparatus of claim 1, further comprising:
a load balancing stage to write metadata to the second slot designating the co-processor to perform processing of the second job.

16. The apparatus of claim 1, wherein the plurality of slots are ordered corresponding to a temporal order in which the first data and the second data are stored in the memory ring, and the processor and the co-processor are to access the first slot and the second slot and process the first job and the second job in an order that is independent of the temporal order.

17. The apparatus of claim 1, wherein the memory ring comprises a lockless ring to be shared in parallel accesses by the processor and the co-processor.

18. At least one non-transitory machine-readable storage medium having stored thereon instructions that, when executed by at least one machine, cause the at least one machine to perform operations comprising:
receiving a plurality of data packets be processed from network fabric;
assigning the plurality of data packets to slot entries of a memory ring based on a temporal order in which the plurality of data packets are received;
a processor core applying a set of rules to selectively identify entries of the plurality of slot entries of the memory ring and processing data packets assigned to the slot entries selectively identified by the processor core; and
a co-processor applying the set of rules to selectively identify entries of the plurality of slot entries of the memory ring and processing data packets assigned to the slot entries selectively identified by the co-processor.

19. The at least one non-transitory machine-readable storage medium of claim 18, storing instructions that when executed by the at least one machine cause the at least one machine to:
for a first data packet of the plurality of data packets, determine whether the memory ring is full based at least in part on comparison of an input slot sequence number to an output slot sequence number; and
based at least in part on a result of the comparison, selectively assign the first data packet to a slot of the plurality of slots represented by a value of the input slot sequence number.

20. The at least one non-transitory machine-readable storage medium of claim 19, storing instructions that when executed by the at least one machine causes the at least one machine to, for a first data packet of the plurality of data packets, store metadata representing completion of processing of the first data packet in the slot assigned to the first data packet.

21. The at least one non-transitory machine-readable storage medium of claim 18, storing instructions that, when executed by the at least one machine, causes the at least one machine to:
identify a slot of the plurality of slots based at least in part on an output slot sequence number; and
read metadata from the identified slot based at least in part on the output slot sequence number to determine whether the data packet associated with the identified slot has been processed.

22. The at least one non-transitory machine-readable storage medium of claim 18, the storage medium storing instructions that when executed by the at least one machine causes the at least one machine to perform operations comprising:
the co-processor processing a first data packet based on data contained in a first field of a first slot of the plurality of slots; and
another co-processor processing the first data packet based on data contained in a second field of the first slot.

23. The at least one non-transitory machine-readable storage medium of claim 22, wherein at least part of the processing of the first data packet based on the data contained in the first field and the processing of the first data packet based the data contained in the second field occur in parallel.

24. The at least one non-transitory storage medium of claim 22, wherein at least part of the processing of the first data packet based on the data contained in the first field and the processing of the first data packet based the data contained in the second field occur sequentially.

25. A method comprising:
receiving a plurality of data packets be processed from network fabric;
assigning the plurality data packets to slot entries of a memory ring based on a temporal order in which the plurality of data packets are received;
a processor core applying a set of rules to selectively identify entries of the plurality of slot entries of the memory ring and processing data packets assigned to the slot entries selectively identified by the processor core; and
a co-processor applying the set of rules to selectively identify entries of the plurality of slot entries of the memory ring and processing data packets assigned to the slot entries selectively identified by the co-processor.

26. The method of claim 25, wherein assigning the data packets to slot entries of a memory ring comprises:
for a first data packet of the plurality of data packets, determining whether the memory ring is full based at least in part on comparison of an input slot sequence number to an output slot sequence number; and
based at least in part on a result of the comparison, selectively assigning the first data packet to a slot of the plurality of slots represented by a value of the input slot sequence number.

27. An apparatus comprising:
means for assigning a plurality of data packets received from a network fabric to slot entries of a memory ring based on a temporal order in which the plurality of data packets are received;
a processor core applying a set of rules to selectively identify entries of the plurality of slot entries of the memory ring and processing data packets assigned to the slot entries selectively identified by the processor core; and
a co-processor applying the set of rules to selectively identify entries of the plurality of slot entries of the memory ring and processing data packets assigned to the slot entries selectively identified by the co-processor.

28. The apparatus of claim 27, further comprising:
means for determining, for a first data packet of the plurality of data packets, whether the memory ring is full based at least in part on comparison of an input slot sequence number to an output slot sequence number; and
means for selectively assigning the first data packet to a slot of the plurality of slots represented by a value of the input slot sequence number based at least in part on a result of the comparison.

29. The apparatus of claim 27, further comprising:
means for storing, for a first data packet of the plurality of data packets, metadata representing completion of processing of the first data packet in the slot assigned to the first data packet.

30. The apparatus of claim 27, further comprising:
means for identifying a slot of the plurality of slots based at least in part on an output slot sequence number; and
means for reading metadata from the identified slot based at least in part on the output slot sequence number to determine whether the data packet associated with the identified slot has been processed.
